(19) United States
(12) Patent Application Publication
(10) Pub. No.: US 2026/0183710 A1
(43) Pub. Date: Jul. 2, 2026

(54) BIOFILTER AND METHOD FOR THE BIOLOGICAL OXIDATION OF METHANE USING COPPER MINING TAILINGS

(71) Applicants: UNIVERSIDAD BERNARDO O’HIGGINS, Santiago (CL); PONTIFICIA UNIVERSIDAD CATÓLICA DE VALPARAÍSO, Valparaíso (CL)

(72) Inventors: Daniel Alfredo VALENZUELA HEREDIA, Santiago (CL); Germán Eduardo AROCA ARCAYA, Valparaíso (CL)

(21) Appl. No.: 19/127,289

(22) PCT Filed: Nov. 3, 2023
(86) PCT No.: PCT/CL2023/050101

§ 371 Date: Jul. 2, 2025

(30) Foreign Application Priority Data
Nov. 4, 2022 (CL) 202203078

(51) Int. Cl. B01D 53/85; B01D 53/34; B01D 53/72

(52) U.S. Cl. CPC B01D 53/85; B01D 53/346; B01D 53/72; B01D 2251/95; B01D 2257/7025; B01D 2258/02

(57) ABSTRACT

The invention relates to a biofilter and a method for the oxidation of methane generated in industrial, agricultural and sanitary landfill processes, among others, where the methane oxidation is biological, requiring methanotrophic microbial consortia, and where copper mining tailings are added to stimulate methane oxidation mediated by said methanotrophic microorganisms.

### TECHNICAL FIELD

The present invention focuses on a biofilter and method that allows the oxidation of methane generated in industrial, agricultural and landfill processes, among others.

### BACKGROUND AND PREVIOUS ART

Methane (CH₄) currently makes up 25% of the planet's radiative forcing. Despite the fact that a constant increase entails an imminent risk to the stability of the biosphere, various human activities continue to emit large amounts of greenhouse gases. It is estimated that, in 20 years under current emission rates, the concentration of greenhouse gases will double (Mohanty et al. 2014). Faced with this scenario, the need arises to carry out research and technological development projects, which allow for the controlling of the emissions of these gases.

Biofiltration is a proposed technology for the removal of CH₄ present in residual gaseous emissions. This biotechnology uses the metabolic capacity of methanotrophic microorganisms, mainly bacteria and archaea, to oxidize the CH₄ present in emissions that cannot be energetically recovered.

Conventional biofilters consist of a bioreactor with three components: support, biofilm and gas phase, the latter containing the contaminant to be removed. The support corresponds to a solid bed on which the methanotrophs are hosted, giving them the physical, chemical and biological conditions to achieve high levels of microbial activity. In some biofiltration systems, the bed is totally inert to the use by the microorganisms, in such cases nutrients must be added to the system. Another type of system for the biological elimination of CH₄ is liquid phase bioreactors, in which the microorganisms are dispersed on a liquid bed and the gas is introduced in the gas phase. In this type of system, microorganisms can be grown in batches or continuously, while the gas can be fed in pulses or steadily over the bed. This depends on the nutritional requirements, the generation of toxic waste, or the requirements of the biofiltration process, such as consumption speeds or product generation.

Methanotrophs play a significant role in the biosphere, as they act in the carbon, nitrogen and oxygen cycle, as well as in the degradation of toxic organic compounds. These bacteria are the main microbial group that have the metabolic abilities to oxidize CH₄. Globally, CH₄ emissions could be considerably higher without methanotrophic activity, as it is estimated that this mitigates 50% of biogenic emissions.

Aerobic methanotrophic bacteria have the ability to use CH₄ as their sole source of carbon and energy. They are affiliated with the phyla Proteobacteria (alpha and gamma subdivisions) and Verrucomicrobia, with the phylum proteobacteria being the predominant one in abundance and functionality in natural and anthropogenic environments. Methanotrophs are specialists, to the extent that they can only grow on CH₄ and its C-1 derivatives, such as methanol (CH₃OH). They do not possess the ability to grow on complex hydrocarbons, such as sugars or organic acids. Because of this, all the C—C bonds that make up the cellular components must be synthesized de novo.

Due to their genetic and physiological characteristics, methanotrophs belonging to the phylum proteobacteria are conventionally divided into two groups; type I and type II methanotrophs. Their abundance is affected by variations in the availability of essential nutrients. Nutrients such as copper, nitrogen, oxygen, potassium and phosphorus are determining factors for the effectiveness of CH₄ biofiltration, since they are necessary for the growth and activity of microorganisms. These nutrients, although they may be bioavailable in the biofilter support, usually require addition (Nikiema et al. 2007).

CH₄ oxidation is an exothermic reaction that is catalyzed by a monooxygenic methane (MMO) enzyme. This enzyme can occur in two forms, soluble in the cytoplasm (sMMO) or attached to the cytoplasmic membrane (pMMO). While all methanotrophs have pMMOs, except for those belonging to the genus Methylocella, only some have the soluble version of the enzyme. Methanotrophs containing pMMO grow more rapidly and are more specific for CH₄ than those with sMMO (Nikiema et al. 2007). pMMO requires copper as an enzymatic cofactor, which makes it necessary to add it in biological methane oxidation processes.

It has been reported that the Copper: Biomass ratio is one of the most important factors in the control of methanotrophic activity (Semrau et al. 2009). Copper at concentrations above 1 μM inhibits the expression of genes encoding the sMMO enzyme, but stimulates the presence of pMMO, an enzyme whose rates of change (Vm) are much higher than those of its soluble pair. The addition of 20 mg CuCl₂ per kg of soil stimulates the oxidation of CH₄ (Mohanty et al. 2000). Van der Ha et al. (2010) demonstrated that 0.64 mg L-1 of CuSO₄ increased CH₄ biofiltration, possibly through stimulation of pMMO activity.

Currently, the use of specific copper salts to stimulate methane-oxidizing metabolic activity involves a high cost to apply it in the field.

Tailings are a finely ground solid, which is discarded in mining operations, it is characterized as rock and minerals. When the tailings contain pyrite, which is very common in tailings in northern Chile, it reacts with water and oxygen, generating acid drainage. For this reason, mining companies must normally build deposits to dispose of the tailings isolated from the surrounding ecosystem.

The inventors have found that the “tailings” product contains copper at concentrations that allow for the activity of microorganisms and the removal of methane. This finding is surprising, given that, due to the nature of the tailings, high in minerals, such as pyrite or other sulfides, it would not be obvious to use it in a bioreactor, since it would be assumed that it could be adverse for bacteria.

On the other hand, the “tailings” product is today considered waste, so the background presented for this invention allows its valorization as a new product, which is recommended to favor the elimination of methane emissions generated in different industrial activities and that cannot be used as an energy resource due to its low concentration. Additionally, based on the background of the literature, it can be considered as a product to stimulate the biological elimination of nitrous oxide (N₂O), the third most important greenhouse gas, after CO₂ and CH₄.

In the state of the art we find some documents close to the present invention, although none anticipates it.

For example, the US2008102515 document, which is equivalent to the Chilean application 200602910, which is rejected, and was submitted by the national company Biosigma. US2008102515 discloses a method that uses pyrite-containing mining products, and by-products such as copper concentrates, and the residues of the process in which these concentrates are obtained as a source of energy for the large-scale cultivation of an association of iron and sulfur oxidizing microorganisms of the type Acidithiobacillus ferrooxidans and Acidithiobacillus thiooxidans together, with or without other native bacteria, in the process of bioleaching minerals in reactors. This document points to bioleaching, and does not refer to the oxidation of methane or nitrous oxide, so it would not affect the novelty of the invention presented here.

RU2011147128 This document discloses (Summary; claims 1, 3, 6 and 7) a method for oxidizing carbon monoxide (CO) and volatile organic compounds (VOCs) which involves bringing into contact a gas containing water vapour and said COs and VOCs with a catalyst composition comprising, among others, at least one metal as a catalyst which is preferably copper and where said VOCs may comprise methane and/or methyl bromide, benzene, methanol, methyl ethyl ketone, butane or butene. This paper provides several examples of the conversion of different gases, but does not provide direct results of methane oxidation in the presence of copper. In addition, it does not mention the alternative of using any type of methanotrophic microorganisms or material from mining waste, so it does not anticipate the invention.

RU2591118 This document discloses a method for ensuring the environmental safety of an underground gas storage facility, including injection through a well, storage and extraction of the gas from the storage facility, by controlling the methane content in the surface atmosphere; If a higher concentration of methane is detected in the surface atmosphere, the soil is treated with a suspension of methanotrophic bacteria in a saline solution comprising, among other compounds, copper sulphate. This document does not refer to the alternative of using copper from waste from mining activity, so it would not affect the novelty of the invention.

As can be seen, there is no solution to the problems inherent in a methane oxidation method, generated in industrial and agricultural processes, or in landfills, among others, through a biofilter that uses tailings from the copper mining industry as an additive that positively impact the efficiency of methane oxidation.

There is no obvious reason why an expert in the art would think of using mine tailings to provide copper to the microbial metabolisms involved in the biological oxidation of methane. The present invention demonstrates that the biofilter and method described here allow mining tailings to be used for methane oxidation using methanotrophic microbial consortia.

### BRIEF DESCRIPTION OF FIGURES

FIG. 1. Biofilter schematic for biological methane removal. 1-A. Invention Fiofilter Schematic: Column filled with mixed substrates including tailings discarded from copper mining. Segmented biofilter to prevent compaction of the substrate. Inlet of the humidified gaseous stream at the base of the biofilter and a gas monitoring system at the top of each section. 1-B. Photograph of the biofilter made in example 1.

FIG. 2. Methane consumption and copper concentration in different substrates. Left axis shows the rate of methane consumption (circles) on different substrates and the right axis shows the concentration of copper on those same substrates (crosses).

The substrates evaluated were: S: Sand. C: Compost. TL: Tailings with low copper content. TH: Tailings with high copper content, and their mixtures Average consumption rate with n=3. It is observed that surprisingly the best methane consumption is not proportional to the higher concentration of copper, but is obtained with the mixture of Compost and Tailings substrates with low copper content.

### DETAILED DESCRIPTION OF THE INVENTION

As indicated, the invention corresponds to a biofilter and method of oxidation of methane generated in industrial and agricultural processes, and in sanitary landfills, among others, where methane oxidation is biological, requiring methanotrophic microbial consortia and where tailings from copper mining are added to stimulate methane oxidation mediated by said methanotrophic microorganisms.

In a first aspect, the invention includes a biofiltration system designed for the oxidation of methane, where the biofilter has a tubular-shaped outer casing, with ascending sections, separated from each other, where the first section or lower section may be of a lower height, since one of its functions is to cushion the entry of gases into the biofilter, and 2 or more upper sections for fill containment, where the fill is a mixture of organic and inorganic materials, mine tailings and methanotrophic microorganisms, i.e. they oxidize methane, the lower section comprises this same fill. The biofilter has a lower connection for the methane-containing gas inlet, and an upper outlet for the recovery of the treated gas. In addition, each section has sampling points for filling or supporting material, an irrigation system, to prevent substrates and biomass from drying out, where it is moistened through this irrigation system with water, and a gas sampling point and a system for adjusting the inflow stream of methane containing methane to a methane concentration to be reduced of between 0.2 and 3.5%. Conveniently, the inlet gas flow is adjusted between 0.2 and 0.5 L min⁻¹. Along with the above, the lower section has a valve that allows the recovery of leachate.

The tubular shape of the biofilter can be cylindrical, or have a polygonal shape, without this being relevant to the function of the biofilter.

In a particular embodiment, the housing has a tubular, cylindrical shape, where the diameter: height ratio is between 1:7 and 1:13.

Each section of the biofilter is separated from each other by means of a mesh that supports the filling, which prevents compaction of the support due to pressure on the column. Conveniently the height of the entrance section is between 10 to 30 cm and the height of the following sections ranges from 25 to 60 cm. In one embodiment, the biofilter contains 4 sections in total, counting the input section.

The filling of the biofilter or support corresponds to a material that allows the growth of methanotrophic microorganisms, and is selected between organic and inorganic materials. In the case of organic landfills, you can use leaf soil, compost, peat, cochayuyo pellet, wood pellet or coconut fiber. On the other hand, the inorganic filler or support, whose main function is to prevent the compaction of the organic filler, is selected between perlite, sand, polymer pellet, glass or stones, the function of this inorganic filler is to prevent the compaction of the substrate, and must have a granulometry of 3 to 5 mm. Additionally, the biofilter always includes mine tailings, with concentrations between 10 and 300 milligrams of copper per kilogram of tailings, especially between 40 and 80 mg Cu/Kg tailings. In a more specific realization, the biofilter filling corresponds to a combination of organic fillers, inorganic fillers and mining tailings, in a ratio between 1:1:1 and 3:1:1. In another even more specific realization, the components of the landfill are compost or leaf soil, perlite and mine tailings for the filling of the biofiltration systems.

In a second aspect, the invention considers a method for methane oxidation using the previously described biofilter.

In a particular embodiment, the method for methane oxidation using a biofiltration system of the invention comprises the following steps:
a. providing a biofilter with a tubular outer casing with solid support consisting of a mixture of organic support, an inorganic support and copper mining tailings, organized in 3 or more ascending sections;
b. inoculating the biofilter filler with methanotrophic microorganisms;
c. connecting the lower section of the biofilter to a methane gas source to be oxidized;
d. allowing the flow of methane gas through the biofilter, where in a first stage the gas enters the lower section of the biofilter, and where said lower section of the biofilter allows the gas to enter the biofilter;
e. measuring the concentrations of gases in the different sections of the biofilter;
f. Obtaining an output gas with a methane concentration lower than the input concentration.

The nature of the methanotrophic microorganisms, which are inoculated in point 3, is not relevant, as long as they fulfill the function, that is, it is not necessary to study or know which are the species present in the inoculum. Example 2 shows a way to select a methanotrophic consortium from a soil where this microbiological activity is considered to exist. However, inoculum can be obtained in any form available in the technique. For example, bacteria that have such activity can be purchased, they can be selected in a methane-rich atmosphere, as indicated in example 2, and of course, once you have a functional reactor, it can be used as an inoculum source for a second reactor.

In one embodiment, the amount of methane incorporated into the biofilter is established based on 2 parameters, the methane concentration in the inlet stream and the feed flow. In a more specific realization, the methane gas concentration is adjusted to a value between 0.2 and 3.5 % CH₄ and the flow to a value between 0.2 and 0.5 L min⁻¹.

In one embodiment, the residence time of the gaseous stream containing the methane is established based on the relationship between the feed flow and the size of the biofilter. In a more specific realization, the residence time of the gaseous stream in the biofilter is established between 10 and 30 minutes. The residence time can be set between 1 minute to 24 hours.

### EXAMPLES

### Example 1. Development of a Biofilter of the Invention

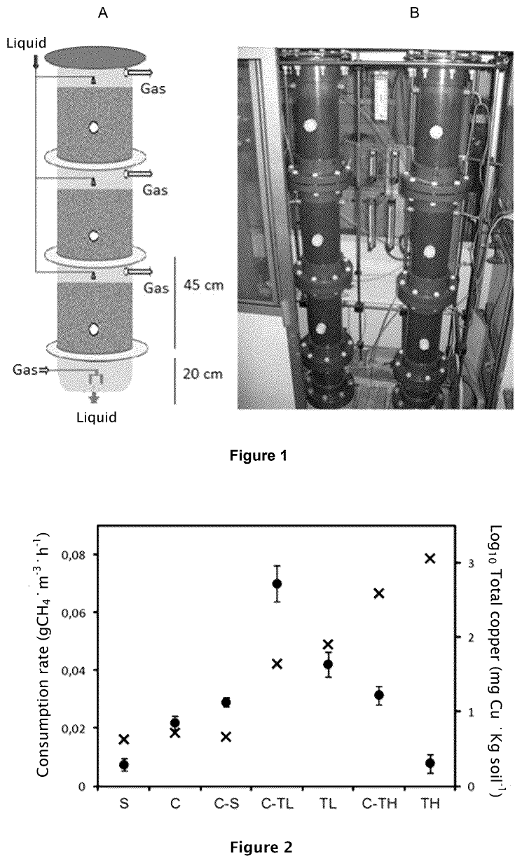

The system that constitutes the biofilter of the invention was developed in a column 170 cm high divided into four sections, as shown in FIG. 1-A. A 6″ Sch.40 clear PVC pipe (Harvel Plastic Inc.) was used for its construction. To assemble the sections of the biofilters, 6″ flanges (Vinilit S. A) were used, which were joined with M12×85 plastic bolts (Malvar).

The lower section, 20 cm high, fulfils the function of buffering and homogenising the gas mixture at the entrance to the column. The upper sections, of 45 cm, contain the filling, constituting the functional volume of the biofiltration system (20 litres). In each section there is a support sampling point, an irrigation system and a gas sampling point. PG29 polyamide cable glands (Legrand) were used to take support samples. PG9 polyamide cable glands (Legrand) were used for the inlets and outlets of the gases, which were also used for the inlet of the irrigation system in each section. The base section has a PVC valve for leachate recovery. FIG. 1 shows a diagram of the biofilter indicating its dimensions.

Each section was filled with a mixture of compost, perlite and tailings from copper mining (2:1:1), which was sterilized 3 times in an autoclave with 24-hour intervals between each process (103 kPa and 121° C. for 20 minutes each sterilization process). The substrates were sifted, using particles with a granulometry of +3 mm to form the support, except in the case of tailings, which presented a granulometry of +0.18 mm.

### Example 2. Obtaining Methanotrophic Bacteria

Samples were taken from landfill soil, where there is presumably methanotrophic activity.

30 grams of soil sample were incubated in 125 ml serum bottles under an atmosphere of CH₄ 30% v/v for 48 hours at 30° C., obtaining soil enriched in methanotrophic microorganisms.

One gram of enriched soil was used to inoculate a liquid-phase culture system in 25 mL of NMS culture medium contained in 125 mL serum bottles. The samples were incubated at 30% v/v CH₄, 30° C. and 200 rpm. Every 24 hours, 0.5 ml of the headspace was taken, which was analyzed by gas chromatography.

After 48 hours, once CO₂ generation was observed, 100 μl of the culture was taken, which was transferred to NMS culture medium and incubated under the same conditions already described. 5 transfers were made for each sample, obtaining consortia of methanotrophic microorganisms.

The nature of the microorganisms present in these consortia was studied by sequencing 16S and the pmoA gene of the strains present.

The taxonomic identification, with respect to the sequences included in PubMed's GeBank, showed that one of the strains present had a similarity of 98% with respect to the bacterial genus of Methylosinus, several strains corresponded to the genus Methylocystis with a similarity score of 100%. Other genera identified by ribosomal sequences were Azospirillum, Aureimonas, Acinetobacter and Sphingobacterium, with a similarity score≥94%.

Identification by the functional gene pmoA corroborated the presence of methanotrophic bacteria affiliated with the genus Methylocystis with a similarity of 99%. The pmoA genes encode a subunit of methane monooxygenase particles (pMMOs), so they are considered a biomarker of aerobic methanotrophic communities.

This demonstrates that the method of the invention is efficient in the selection of methanotrophic microorganisms. Those that will probably be of the genera described, however the species of the methanotrophic microorganism is not a relevant condition for the invention.

### Example 3. Effect of Tailings on Methanotrophic Activity

To evaluate the effect of adding tailings to a biofilter with methanotrophic bacteria, the inventors compared the methane consumption rate in biofilters with different compositions, sand (S), compost (C) and mining tailings (TL) with low copper concentration (50 mg Cu/Kg tailings) or mining tailings (TH) with high copper concentration (300 mg Cu/Kg tailings) alone or in combination were evaluated. Each experiment was performed in triplicate.

Methanotrophic activity tests were performed in flasks with mininert valves. In each flask, 10 ml of the previously sterilized support to be evaluated was deposited. The support sterilization procedure consisted of one or two successive autoclaves, with a 24-hour intermission at room temperature.

Subsequently, each support or mixture was inoculated with 2 ml of a culture of methanotrophic microorganisms, obtained in example 2, as a control it was irrigated with 2 ml of sterile H₂O (d).

For the analysis of support mixtures, 1:1 mixtures were performed.

Each flask was injected with 15 mL of CH₄. The pressure of the flasks operating during the oxidation kinetics of CH₄ was measured. A digital manometer (PCE-P05 PCE instruments) was used for this. The working pressure in the culture system was brought to atmospheric pressure at the beginning of the experiments.

A periodic quantification of the concentration of gases in the gas phase was performed. The quantification of the concentration of CH₄ and CO₂ in the gas phase was performed by gas chromatography on the Clarus-500 equipment (Perkin-Elmer).

The results are shown in FIG. 2. As can be seen, the best methane oxidation was achieved with the mixture of tailings and compost, at a total copper concentration of 50 mg of copper per kilogram of soil.

The quantification of gases was carried out with the Drager X-am 5600 equipment equipped with sensors for CO₂, CH₄, O₂, NH₃ and H₂S. CO₂ and CH₄ were quantified as a percentage v/v air with the DrägerSensor Dual IR Ex/CO₂ infrared sensor, calibrated by the manufacturer with standard CO₂ and CH₄ concentrations.

These results show that the best substrate combination for the biofilter of the invention is the tailings and compost mixture, and always tailings with low copper content.

1. A biofiltration system for methane oxidation comprising:
a) a biofilter with a tubular outer casing comprising a mixture of methanotrophic microorganisms and a solid support consisting of a mixture of organic support, an inorganic support, and copper mining tailings, in 3 or more ascending sections;
b) a connection in a lower section of the biofilter for an inlet of gas containing methane;
c) a means of detecting the concentration of the methane gas in an upper part of the biofilter;
d) a system for adjusting the inlet of the gas stream containing methane to a methane concentration to be reduced to be in a range from 0.2 to 3.5%; and
e) an upper outlet for recovery of treated gas.

2. The system according to claim 1, wherein the organic support is selected from the group consisting of leaf soil, compost, peat, cochayuyo pellet, and mixtures thereof.

3. The system according to claim 1, wherein the inorganic support is selected from the group consisting of perlite, sand, gravel, volcanic soil, vermiculite, expanded clay, rock wool, furnace slag, and mixtures thereof.

4. The system according to claim 1, wherein the solid support of the biofilter comprises a proportion between organic and inorganic support and copper mining tailings in a range from 1:1:1 to 3:1:1.

5. The system according to claim 1, wherein in step d), a flow of the gas stream is adjusted to be between 0.2 and 0.5 L min⁻¹.

6. The system according to claim 1, wherein the copper mining tailings have a concentration in a range from 10 mg to 300 mg of copper per Kg of tailings.

7. The system according to claim 5, wherein the copper mining tailings are at a concentration of in a range from 40 to 80 mg of copper per Kg of tailings.

8. The system according to claim 1, wherein the biofilter comprises a housing with 3 or more sections.

9. The system according to claim 8, wherein each section of the biofilter is separated from each other by a mesh that supports filling, so that compaction of the solid support due to pressure from a column is prevented.

10. The system according to claim 8, wherein each section has sampling points for filling or support material, an irrigation system, and a gas sampling point.

11. The system according to claim 1, wherein the lower section has a valve that allows recovery of leachates.

12. The system according to claim 1, wherein the tubular casing has a diameter:height ratio in a range from 1:7 to 1:13.

13. A method for the methane oxidation using the biofiltration system according to claim 1, the method comprising:
a) providing a biofilter with the tubular outer casing with the solid support consisting of the mixture of the organic support, the inorganic support, and the copper mining tailings, organized in the 3 or more ascending sections;
b) inoculating the biofilter filling with the methanotrophic microorganisms;
c) connecting the lower section of the biofilter to a source of the methane gas to be oxidized;
d) permitting a flow of the methane gas through the biofilter, where at first, the gas enters the lower section of the biofilter, wherein said lower section of the biofilter allows entry of the gas into the biofilter to be buffered;
e) measuring gas concentrations in different sections of the biofilter; and
f) obtaining an output gas with a methane concentration lower than an input concentration.

14. The method for the methane oxidation according to claim 13, wherein in the d), an amount of the methane incorporated into the biofilter is established based on 2 parameters, which are the input concentration of the methane gas in the inlet stream and a feed flow.

15. The method for the methane oxidation according to claim 14, wherein the input concentration of the methane gas is adjusted to be in a range from 0.2 to 3.5% CH₄ and the flow to be in a range from 0.2 to 0.5 L min⁻¹.

16. The method for the methane oxidation according to claim 13, wherein a residence time of the gas stream containing the methane is established based on a relationship between a feed flow and a size of the biofilter.

17. The method for the methane oxidation according to claim 16, wherein the residence time of the gas stream in the biofilter is established in a range from 1 minute to 24 hours.
